(19) United States
(12) Patent Application Publication
(10) Pub. No.: US 2026/0171092 A1
(43) Pub. Date: Jun. 18, 2026

(54) SYSTEM AND METHOD FOR CONVERTING A MINIMUM PORTION OF AN INCOMING CALL TO TEXT BASED ON AMBIENT NOISE LEVEL

(71) Applicant: MOTOROLA SOLUTIONS, INC., CHICAGO, IL (US)

(72) Inventor: KIM KOON NEOH, BAYAN LEPAS (MY)

(21) Appl. No.: 18/981,729

(22) Filed: Dec. 16, 2024

(51) Int. Cl. G10L 15/26; G10L 15/20; H04M 3/42

(52) U.S. Cl. CPC G10L 15/26; G10L 15/20; H04M 3/42221; H04M 2201/60

(57) ABSTRACT

A method for converting a minimum portion of an incoming call to text based on ambient noise level is provided. An ambient noise level is monitored at a communication device. A current volume level of an output element of the communication device is monitored at the communication device. An incoming call is received at the communication device. A portion of the incoming call that is unintelligible when the ambient noise level exceeds a threshold volume level of the output element of the communications device is identified. A minimum portion of the incoming call that includes the portion of the incoming call that is unintelligible is determined. The minimum portion of the incoming call is converted to a text based message. The text based message is displayed on the communication device.

### BACKGROUND

Public safety responders (e.g. police, fire, emergency medical services, etc.) often use two way radios for mission critical communications. Some examples of such radio communications networks include those based on Project 25 (P25) in North America and TETRA outside of North America. These systems allow for highly reliable communications in critical situations. Two way radios may also be used in any number of less critical fields as well (e.g. utilities, retail, industrial, etc.).

Often times, the radios take the form of portable radios (e.g. walkie talkie, etc.). In some cases, the radios may be mobile radios. For example, a radio mounted in a vehicle. In many cases, these radios may operate in noisy environments. To keep background noise from interfering with a person speaking into there two way radio, many different techniques have evolved. For example, directional microphones can limit the direction in which audio is captured by performing beamforming to capture audio in the direction of the speakers mouth. Noise cancelation techniques, including active noise cancelation, can also reduce the amount of background noise captured by the microphone of the two way radio.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is an example of an environment where the techniques described herein may be implemented.

FIG. 2 is an example flow diagram of an implementation of the techniques described herein.

FIG. 3 is an example of a hardware device that may implement the techniques described herein.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

Although the various techniques used at the transmitting side of a two-way radio to ensure that the transmitted audio is clear, there can also be problems at the receive side that make communications difficult to understand. For example, a user may be in an environment that experiences time periods punctuated by high levels of transient ambient noise. This high level of transient ambient noise may make it difficult for a recipient to hear communications coming in over the two-way radio when the transmission occurs, at least in part, during one of those periods of high levels of transient ambient noise.

For example, consider an officer patrolling near a construction site where a jackhammer is in use. Assume the jackhammer is turned on for 5 seconds, followed by a twenty second period of non-use (e.g. while the jackhammer is repositioned) with the cycle repeating. If a communication is received, it is possible at least some portion of the communication occurs during the period where the jackhammer is operational and that portion of the communication could be obscured by the high level of ambient noise. A naive solution to this problem may be simply to have the two-way radio always play incoming communications at the highest possible volume. This introduces a new problem in that the higher the volume level, the more power (e.g. battery, etc.) is used, thus reducing the time between recharging the two-way radio. As another problem, in particular in the case of a police officer, setting the volume too high may allow others to hear communications that should not be heard.

As yet another example, consider a security guard operating at a beach vacation resort. The security guard may have the volume of his two-way radio set to a very low level so as to not disturb the resort guests. However, at unpredictable times, sudden crashing of the ocean waves may occur. If this were to occur while a call was being received over the two-way radio, the security guard would not be able to hear at least some portion of the call.

When a portion of the incoming call is not able to be heard by the recipient, the recipient may request a repeat of the transmission. For example, if the recipient is a police officer receiving a call from a dispatcher and at least a portion of the call could not be heard due to the transient noise, the officer may request the dispatcher repeat the call. Since the dispatcher has no idea what portions of the call could not be heard, the dispatcher has no choice but to repeat the entire call. This is problematic for several reasons, First, two way radio systems are typically broadcast systems with many users sharing the same channel. When the call is repeated it occupies the communication channel for all users. Furthermore, repeating the call may cause distraction to other users who were not experiencing the high level of transient noise. Furthermore, repeating the entire call may not be an efficient use of resources if only a smaller portion of the call could not be heard. For example, if the total call length was 30 seconds, but the high level of transient noise (e.g. 5 seconds of jackhammer, etc.) was less than the total call length, it would be inefficient to repeat the entire 30 seconds of the call.

The techniques described herein overcome these problems, and others, individually and collectively. When an incoming call is received at the two-way radio, the call is recorded by the two-way radio. Before it is played out via the speaker of the two-way radio. As such, the recording is not subject to any ambient noise that may be present in the environment, regardless of if the ambient noise is constant or transient. At the same time, the microphone of the two-way radio is activated to monitor the level of ambient noise around the two-way radio.

The sound level of the ambient noise is compared to the volume level of the speaker of the two-way radio throughout the duration of the call. Portions of the recording during which the sound level of the ambient noise is greater than a threshold value of the volume level of the speaker of the two-way radio are noted. These portions of the call have the possibility that they were not heard, due to the level of ambient noise.

Using Natural Language Processing (NLP), the received audio is analyzed during the noted portions of the recording of the call. The start and end point of the sentence which included the noted portion of the call are determined. NLP and Large Language Model (LLM) analysis is used to determine the shortest possible portion of the noted portions of the recording would be needed to make sense to the listener. That shortest possible portion is then retrieved and converted into text form.

At a later point, for example when the radio is idle and not being used, the display of the two-way radio may present the converted text. The user may also be given the option to replay the determined shortest possible portion of the recorded audio.

A method is provided. The method includes monitoring, at a communication device, an ambient noise level. The method also includes monitoring, at the communication device, a current volume level of an output element of the communication device. The method also includes receiving, at the communication device, an incoming call. The method also includes identifying a portion of the incoming call that is unintelligible when the ambient noise level exceeds a threshold volume level of the output element of the communications device. The method also includes determining a minimum portion of the incoming call that includes the portion of the incoming call that is unintelligible. The method also includes converting the minimum portion of the incoming call to a text based message. The method also includes displaying the text based message on the communication device.

In one aspect, the method includes buffering the incoming call. In one aspect, the method includes providing to a user of the communication device an option to replay the portion of the incoming call that was identified as unintelligible. In one aspect, the method includes determining the communication device is in an idle state prior to providing the option to replay the portion of the incoming call that was identified as unintelligible.

In one aspect of the method determining the minimum portion of the incoming call that includes the portion of the incoming call that is unintelligible further comprises determining, using natural language processing, a sentence in the incoming call that includes the portion of the incoming call that is unintelligible and determining, using a trained artificial intelligence model, a shortest portion of the sentence to convey a correct meaning of the portion of the incoming call that is unintelligible.

A system is provided. The system includes a processor and a memory coupled to the processor. The memory contains a set of instructions thereon that when executed by the processor cause the processor to monitor, at a communication device, an ambient noise level. The instructions on the memory also cause the processor to monitor, at the communication device, a current volume level of an output element of the communication device. The instructions on the memory also cause the processor to receive, at the communication device, an incoming call. The instructions on the memory also cause the processor to identify a portion of the incoming call that is unintelligible when the ambient noise level exceeds a threshold volume level of the output element of the communications device. The instructions on the memory also cause the processor to determine a minimum portion of the incoming call that includes the portion of the incoming call that is unintelligible. The instructions on the memory also cause the processor to convert the minimum portion of the incoming call to a text based message. The instructions on the memory also cause the processor to display the text based message on the communication device.

In one aspect, the instructions on the memory cause the processor to buffer the incoming call. In one aspect, the instructions on the memory cause the processor to provide to a user of the communication device an option to replay the portion of the incoming call that was identified as unintelligible. In one aspect, the instructions on the memory cause the processor to determine the communication device is in an idle state prior to providing the option to replay the portion of the incoming call that was identified as unintelligible.

In one aspect, the instructions on the memory to determine the minimum portion of the incoming call that includes the portion of the incoming call that is unintelligible further comprises instructions on the memory to determine, using natural language processing, a sentence in the incoming call that includes the portion of the incoming call that is unintelligible and determine, using a trained artificial intelligence model, a shortest portion of the sentence to convey a correct meaning of the portion of the incoming call that is unintelligible.

A non-transitory processor readable medium containing a set of instructions thereon is provided. The instructions on the medium, that when executed by a processor cause the processor to monitor, at a communication device, an ambient noise level. The instructions on the medium also cause the processor to monitor, at the communication device, a current volume level of an output element of the communication device. The instructions on the medium also cause the processor to receive, at the communication device, an incoming call. The instructions on the medium also cause the processor to identify a portion of the incoming call that is unintelligible when the ambient noise level exceeds a threshold volume level of the output element of the communications device. The instructions on the medium also cause the processor to determine a minimum portion of the incoming call that includes the portion of the incoming call that is unintelligible. The instructions on the medium also cause the processor to convert the minimum portion of the incoming call to a text based message. The instructions on the medium also cause the processor to display the text based message on the communication device.

In one aspect, the instructions on the medium cause the processor to buffer the incoming call. In one aspect, the instructions on the medium cause the processor to provide to a user of the communication device an option to replay the portion of the incoming call that was identified as unintelligible. In one aspect, the instructions on the medium cause the processor to determine the communication device is in an idle state prior to providing the option to replay the portion of the incoming call that was identified as unintelligible.

In one aspect, the instructions on the medium to the instructions to determine the minimum portion of the incoming call that includes the portion of the incoming call that is unintelligible further comprises instructions on the medium to determine, using natural language processing, a sentence in the incoming call that includes the portion of the incoming call that is unintelligible and determine, using a trained artificial intelligence model, a shortest portion of the sentence to convey a correct meaning of the portion of the incoming call that is unintelligible.

In one aspect, the output element of the communication device is an earpiece. In one aspect, the ambient noise level is transient.

Further advantages and features consistent with this disclosure will be set forth in the following detailed description, with reference to the figures.

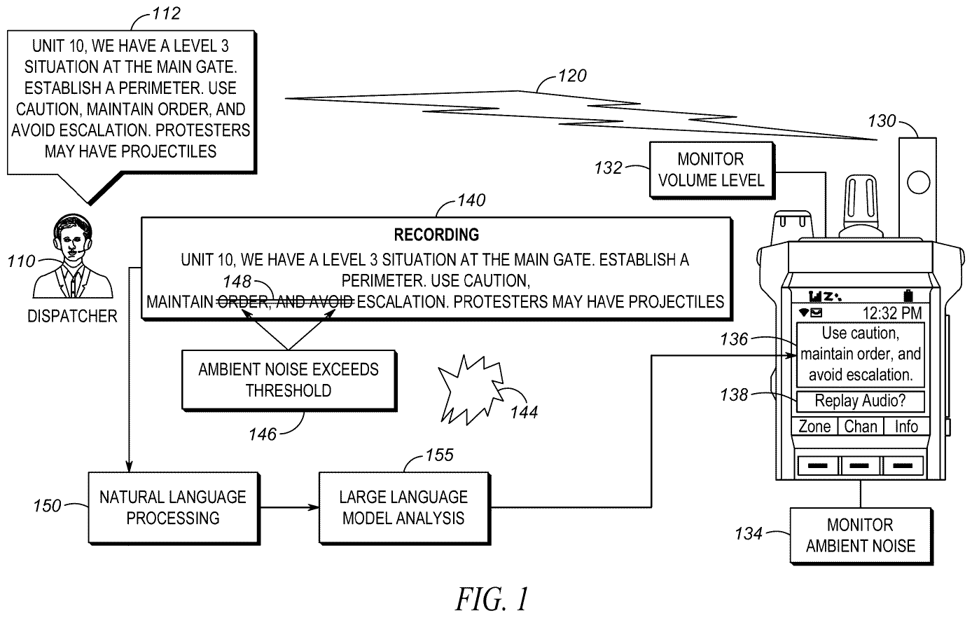

FIG. 1 is an example of an environment 100 where the techniques described herein may be implemented. FIG. 1 includes a dispatcher 110, a Radio Frequency (RF) Infrastructure 120, and a portable radio 130.

The dispatcher 110 represents a person who wishes to communicate with a user of the portable radio 130. The person wishing to communicate is described as a dispatcher because in general, in a public safety context, a dispatcher will provide instructions to field responders (e.g. police officers, etc.) via radio transmission. However, it should be understood that this is for ease of description. The dispatcher can represent anyone that will send a call to the portable radio, regardless of the function of the person sending the call.

The RF Infrastructure 120 represents the RF hardware (not shown) that is utilized to provide wireless communication between the Dispatcher 110 and the portable radio 130. The particular form of the RF infrastructure is unimportant. Some examples of RF infrastructure in the mission critical communications space are those networks based on the Project 25 standard (North America) or those based on the TETRA standard (Europe). Other networks could include 3G, 4G, 5G, LTE, WiFi, Bluetooth, etc. networks. What should be understood is that the techniques described herein can be utilized with any type of RF infrastructure.

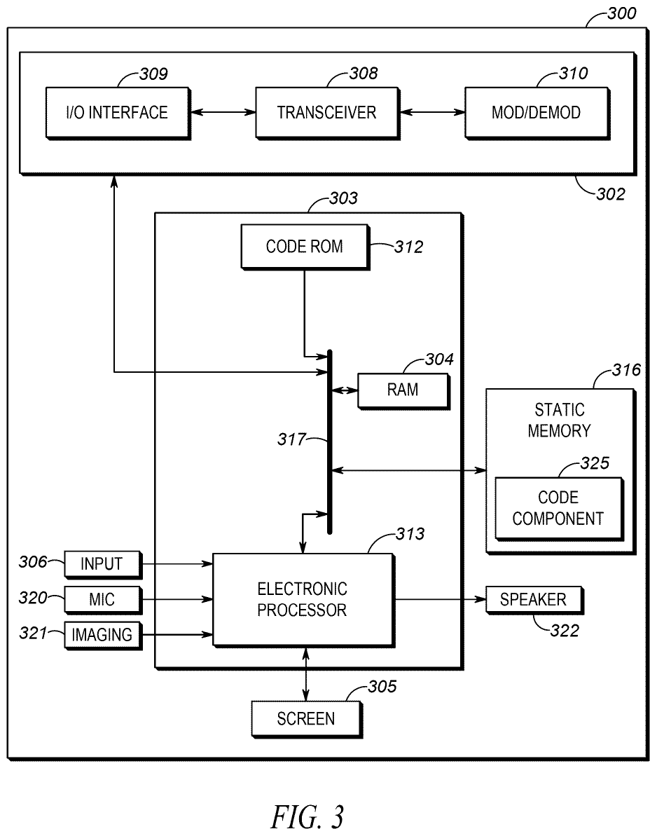

The portable radio 130 represents any radio that is capable of receiving calls over the RF infrastructure. An example of a device that may implement the portable radio is described in further detail below, with respect to FIG. 3. The portable radio, in addition to providing the ability to receive calls, will also monitor 132 the current volume setting of the portable radio. In some cases, the portable radio will output audio via an output element that is a speaker integrated with the portable radio. In other cases, an auxiliary device may be the output element. For example, the portable radio may be equipped with an earpiece (not shown) that the user of the portable radio inserts into their ear to hear calls. As yet another example, the portable radio may be coupled to a remote speaker microphone (RSM) that the user of the portable radio attaches to the lapel of their shirt. What should be understood is that the volume level of the output element, whatever that element is, may be monitored to determine how loud an incoming call will be provided to the user of the portable radio.

The portable radio 130 will also monitor ambient noise 134 in the vicinity of the portable radio. For example, the portable radio is equipped with a microphone that can be used when the portable radio initiates a call. That same microphone can be used to measure the volume level of ambient noise when the user of the portable radio is not engaged in a call. If the case where the portable radio is equipped with an earpiece or a RSM, those devices will also be equipped with a microphone. Regardless of how implemented, what should be understood is that the portable radio will monitor the level of ambient noise in the environment where the portable radio is located.

In operation, the dispatcher 110 may initiate a call 112 with the portable radio 130 to provide information and/or instructions to the user of the portable radio. In this example, the dispatcher communicates, “Unit 10, we have a Level 3 situation at the main gate. Establish a perimeter. Use caution, maintain order, and avoid escalation. Protestors may have projectiles.” This call is sent to the portable radio 130 over the RF infrastructure.

Upon receiving the call, the portable radio may begin recording 140 the call. It should be noted that the recording of the call is done prior to the audio of the call being output from the speaker (or earpiece, RSM, etc.) of the portable radio. In other words, the signal being recorded is the same as the one being used to drive the audio output. As such, the recorded call is not susceptible to ambient noise. The call will also be output over the output element of the portable radio, whatever that output element is (e.g. speaker, earpiece, RSM).

While the audio is being output, the volume level 132 of the portable radio 130 will be monitored. This will be compared to the monitored ambient noise 134 to determine if the ambient noise level exceeds a threshold level with respect to the output volume level. If the threshold is exceeded, it may be inferred that the incoming audio of the call is unintelligible. The threshold may be set based on the particular environment. In some cases, the threshold may be that if the ambient noise is louder than the output volume, the portion of the call will be deemed unintelligible. In other cases, the threshold could be set based on a percentage (e.g. ambient noise level is greater than 75% of the output volume level. The particular setting of the threshold is unimportant. What should be understood is that when the threshold is exceeded, that portion of the call is deemed unintelligible.

At some point, a loud transient noise 144 may occur. For example, in the case of a protest situation, the loud noise may be the explosion of a tear gas grenade or flash bang. In the case of a construction site, the loud noise may be a jackhammer being operated. Regardless, the loud transient noise may occur while a call is in progress. When the loud noise occurs, the ambient noise may exceed the threshold 146. As a result, the recording may be annotated to indicate that the threshold was exceeded. For example, the recording may be annotated to indicate a start timestamp and stop timestamp for the period of time during which the threshold was exceeded. In the present example, the struck through text 148 indicates the portion of the recording where the ambient noise threshold was exceeded.

Once portions of the recording 140 have been marked with start and stop times of when the threshold was exceeded, the recording may be provided to a natural language processing system 150. The natural language processing system analyzes the received audio recording during the period of time the threshold was exceeded. From this analysis, the start and end time of the sentence of the call that includes the portion of the call where the threshold was exceeded can be determined. In this example, the portion where the threshold was exceeded includes the words “order, and avoid”. The overall sentence that includes those words is “Use caution, maintain order, and avoid escalation”.

Once the audio has been processed by the natural language processing 150, it may be sent to a large language model (LLM) analysis system 155 for further processing. For example, the audio of the call could be converted into text and sent to the LLM system for further analysis. For example, the LLM could be presented with a text representation of the call with an indication of the portions of the call where the threshold was exceeded. The LLM could then be asked to determine the minimum portion of the call that needs to be reproduced in order for the potentially missed portion to be understandable.

In the present example, the potentially unintelligible portion were the words “order, and avoid”. In isolation, these words generally do not contain enough information to be intelligible. For example, it raises the question of “order, and avoid” what? The LLM Analysis 155 may determine that in order for this fragment to be understandable, the entire sentence, “Use caution, maintain order, and avoid escalation” needs to be repeated. The large language model may then cause the entire sentence 136 to be displayed in text form 136 on a display of the portable radio 130. Such capabilities are currently available in LLMs. The techniques described herein are not dependent on any particular LLM or LLM analysis technique.

Advantageously, presenting the minimum portion of the call did not require the text of the entire call to be provided, just the portion needed to understand what was missed. Furthermore, it did not require the dispatcher to repeat any portion, up to and including the entire call, over the RF infrastructure. As mentioned above, the communications channel can generally be occupied by one user at a time. If it is occupied by a dispatcher repeating information, this is a waste of the communication resource.

Although the present example is described with the minimum portion of the call corresponding to the full sentence including the portion where the ambient noise exceeded the threshold, this was by way of example, not limitation. In some cases, the nature of the call may only need the portion of the call where the threshold was exceeded to be repeated. In other cases, the minimum portion of the call may include the sentence before, the sentence after, or both to also be included. What should be understood is that the LLM determines the minimum portion based on the call and the portions of the call where the ambient noise exceeds the threshold.

In some implementations, in addition to providing a text output 136 of the minimum portion of the call, the portable radio 130 may also provide an option to replay the audio 138 of the minimum portion of the call. Some portable radios may not include a display or sophisticated user interface. In some implementations, it may be determined first that the portable radio is idle (e.g. not currently receiving or sending a call). Once determined that the portable radio is idle, a voice announcement may be output asking if the user wishes to hear a replay of the minimum portion. If the user responds affirmatively, the minimum portion can be replayed.

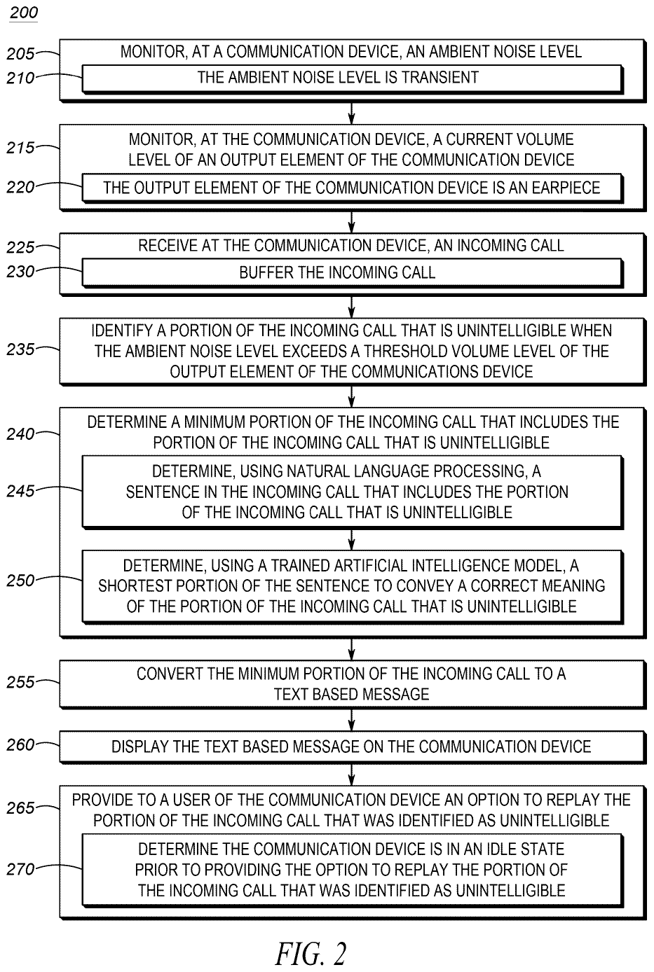

FIG. 2 is an example flow diagram 200 of an implementation of the techniques described herein. In block 205, an ambient noise level is monitored at a communication device. The ambient noise level is a continuous measurement so that the ambient noise level tracks the current level of ambient noise. As such, the ambient noise level captures transient spikes in the ambient noise, as opposed to measuring an average ambient noise or peak ambient noise.

In block 210, the ambient noise that is being measured is transient. In other words, the noise may be high for some portions of time, but relatively low for other portions. For example, the ambient noise may increase temporarily due to activity (e.g. a jackhammer being operated, etc.).

In block 215 a current volume level of an output element of the communication device is monitored at the communication device. The output element of the communication device is the element that is being used to output audio of the call. This level will be used to determine how loud the audio currently being presented to the user of the communication device. In some cases, the output element is the speaker integrated into the communication device. In other cases, the output element may be a RSM coupled to the communication device.

In block 220, the output element of the communication device is an earpiece. In the case where the output element is an earpiece, the volume level is based on the volume that would be heard by the user of the communication device directly at the ear, and would not need to take into account the volume level from a speaker that may be remote from the user. In other words, consideration may be taken as to how far the audio output element is from the ear of the user.

In block 225, an incoming call is received at the communication device. As explained above, an incoming call is an audio communication intended for the user of the communication device. The call can be generated from any other device connected to the RF infrastructure. For example the call could come from a dispatcher. Or the call could come from a peer of the user of the communication device. The source of the call is somewhat unimportant and the techniques described herein are usable regardless of the source of the call.

In block 230, the incoming call is buffered. Buffering the incoming call includes recording the incoming call. In some cases the recording may be stored in a temporary store on the communication device. In other cases, the incoming call is stored in a more permanent store on the communication device. It should be understood that buffering and recording are used interchangeably throughout this description.

In block 235, a portion of the incoming call that is unintelligible when the ambient noise level exceeds a threshold volume level of the output element of the communications device is determined. In other words, portions of the call may be unintelligible based on the levels of ambient noise in comparison with the volume level of the output element of the communications device. In some cases, this may be determined as a percentage of the ambient noise in comparison to the output element volume level.

In block 240, a minimum portion of the incoming call that includes the portion of the incoming call that is unintelligible. As explained above, just repeating the portion of the call that was unintelligible may not result in the ability to understand the original call. For example, several words in isolation may not be sufficient to understand the meaning of the unintelligible portion. The communications device determines the minimum portion of the call that is needed to understand the call. This may include the unintelligible words only, the sentence including the unintelligible portion, a sentence before the sentence including the unintelligible portion, a sentence after the sentence including the unintelligible portion, both the sentence before and after, the entire call, or any other such combination.

In block 245, natural language processing is used to determine a sentence in the incoming call that includes the portion of the incoming call that is unintelligible. In other words, a specific sentence within the incoming call that includes the portion of the call that was unintelligible is determined. The portions of the call including the sentence can be marked in the buffered call.

In block 250, a shortest portion of the sentence to convey a correct meaning of the portion of the incoming call that is unintelligible is determined using a trained artificial intelligence model. A trained artificial intelligence model can also be referred to as a large language model. The large language model is used to analyze the call and determine the minimum of the of the call that includes the unintelligible portion that needs to be reproduced to make the unintelligible portion understandable.

In block 255, the minimum portion of the incoming call is converted to a text based message. By converting the minimum portion of the call to a text based message, further use of the communications channel can be avoided. For example, the dispatcher need not repeat the original call, thus saving dispatcher and communication channel resources.

In block 260, the text based message is displayed on the communication device. The user of the communication device does not need to request a repeat of the call from the dispatcher. The user can simply read the text based message at any suitable time.

In block 265, an option is provided to a user of the communications device to replay the portion of the incoming call that was identified as unintelligible. In other words, the user is given an option to replay a minimum portion of the call that included the unintelligible portion. The audio replay could come from the buffered version of the call. By replaying only the minimum portion, the user is relieved from having to listen to the entire call, when only a portion of the call may have been unintelligible.

In block 270, it is determined that the communication device is in an idle state prior to providing the option to replay the portion of the incoming call that was identified as unintelligible. In some cases, the communications device may be a simple device without a display. In such case, the communication device may wait until the communication device is idle (e.g. not making or receiving a call, etc.). Once the device is idle, a voice announcement may be presented to the user asking if the minimum portion of the call should be replayed. If the user answers affirmatively, the minimum portion of the call is replayed. This allows for the techniques described herein to be used with less sophisticated communications devices that may not include displays.

FIG. 3 is an example of a hardware device 300 that may implement the techniques described herein. The communication device 300 may be, for example, embodied in the portable radio 130, the natural language processing 150, and the large language model 155 and/or may be a distributed communication device across two or more of the foregoing (or multiple of a same type of one of the foregoing) and linked via a wired and/or wireless communication link(s). In some embodiments, the communication device 300 (for example, the portable radio 130) may be communicatively coupled to other devices, such as the RF infrastructure 120.

While FIG. 3 represents the communication devices described above with respect to FIG. 1, depending on the type of the communication device, the communication device 300 may include fewer or additional components in configurations different from that illustrated in FIG. 3. For example, in some embodiments, communication device 300 acting as the infrastructure 120 may not include one or more of the screen 305, input device 306, microphone 320, imaging device 321, and speaker 322. As another example, in some embodiments, the communication device 300 acting as the portable radio 130 may further include a location determination device (for example, a global positioning system (GPS) receiver) as explained above. Other combinations are possible as well.

As shown in FIG. 3, communication device 300 includes a communications unit 302 coupled to a common data and address bus 317 of a processing unit 303. The communication device 300 may also include one or more input devices (e.g., keypad, pointing device, touch-sensitive surface, etc.) 306 and an electronic display screen 305 (which, in some embodiments, may be a touch screen and thus also act as an input device 306), each coupled to be in communication with the processing unit 303.

The microphone 320 may be present for capturing audio from a user and/or other environmental or background ambient audio that is further processed by processing unit 303 in accordance with the remainder of this disclosure and/or is transmitted as voice or audio stream data, or as acoustical environment indications, by communications unit 302 to other portable radios and/or other communication devices. The imaging device 321 may provide video (still or moving images) of an area in a field of view of the communication device 300 for further processing by the processing unit 303 and/or for further transmission by the communications unit 302. A speaker 322 may be present for reproducing audio that is decoded from voice or audio streams of calls received via the communications unit 302 from other portable radios, from digital audio stored at the communication device 300, from other ad-hoc or direct mode devices, and/or from an infrastructure RAN device, or may playback alert tones or other types of pre-recorded audio.

The processing unit 303 may include a code Read Only Memory (ROM) 312 coupled to the common data and address bus 317 for storing data for initializing system components. The processing unit 303 may further include an electronic processor 313 (for example, a microprocessor or another electronic device) coupled, by the common data and address bus 317, to a Random Access Memory (RAM) 304 and a static memory 316.

The communications unit 302 may include one or more wired and/or wireless input/output (I/O) interfaces 309 that are configurable to communicate with other communication devices, such as the RF infrastructure 120.

For example, the communications unit 302 may include one or more wireless transceivers 308, such as a DMR transceiver, a P25 transceiver, a Bluetooth transceiver, a Wi-Fi transceiver perhaps operating in accordance with an IEEE 802.11 standard (e.g., 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network.

The communications unit 302 may additionally or alternatively include one or more wireline transceivers 308, such as an Ethernet transceiver, a USB transceiver, or similar transceiver configurable to communicate via a twisted pair wire, a coaxial cable, a fiber-optic link, or a similar physical connection to a wireline network. The transceiver 308 is also coupled to a combined modulator/demodulator 310.

The electronic processor 313 has ports for coupling to the display screen 305, the input device 306, the microphone 320, the imaging device 321, and/or the speaker 322. Static memory 316 may store operating code 325 for the electronic processor 313 that, when executed, performs the techniques described herein, including one or more of the steps set forth in FIG. 2 and accompanying text.

The static memory 316 may comprise, for example, a hard-disk drive (HDD), an optical disk drive such as a compact disk (CD) drive or digital versatile disk (DVD) drive, a solid state drive (SSD), a flash memory drive, or a tape drive, and the like.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot perform machine implemented natural language processing and artificial intelligence large language model analysis, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
monitoring, at a communication device, an ambient noise level;
monitoring, at the communication device, a current volume level of an output element of the communication device;
receiving, at the communication device, an incoming call;
identifying a portion of the incoming call that is unintelligible when the ambient noise level exceeds a threshold volume level of the output element of the communications device;
determining a minimum portion of the incoming call that includes the portion of the incoming call that is unintelligible;
converting the minimum portion of the incoming call to a text based message; and
displaying the text based message on the communication device.

2. The method of claim 1 further comprising:
buffering the incoming call.

3. The method of claim 1 further comprising:
providing to a user of the communication device an option to replay the portion of the incoming call that was identified as unintelligible.

4. The method of claim 3 further comprising:
determining the communication device is in an idle state prior to providing the option to replay the portion of the incoming call that was identified as unintelligible.

5. The method of claim 1 wherein the output element of the communication device is an earpiece.

6. The method of claim 1 wherein determining the minimum portion of the incoming call that includes the portion of the incoming call that is unintelligible further comprises;
determining, using natural language processing, a sentence in the incoming call that includes the portion of the incoming call that is unintelligible; and
determining, using a trained artificial intelligence model, a shortest portion of the sentence to convey a correct meaning of the portion of the incoming call that is unintelligible.

7. The method of claim 1 wherein the ambient noise level is transient.

8. A system comprising:
a processor; and
a memory coupled to the processor, the memory containing a set of instructions thereon that when executed by the processor cause the processor to:
monitor, at a communication device, an ambient noise level;
monitor, at the communication device, a current volume level of an output element of the communication device;
receive, at the communication device, an incoming call;
identify a portion of the incoming call that is unintelligible when the ambient noise level exceeds a threshold volume level of the output element of the communications device;
determine a minimum portion of the incoming call that includes the portion of the incoming call that is unintelligible;
convert the minimum portion of the incoming call to a text based message; and
display the text based message on the communication device.

9. The system of claim 8 further comprising instructions to:
buffer the incoming call.

10. The system of claim 8 further comprising instructions to:
provide to a user of the communication device an option to replay the portion of the incoming call that was identified as unintelligible.

11. The system of claim 10 further comprising instructions to:
determine the communication device is in an idle state prior to providing the option to replay the portion of the incoming call that was identified as unintelligible.

12. The system of claim 8 wherein the output element of the communication device is an earpiece.

13. The system of claim 8 wherein the instructions to determine the minimum portion of the incoming call that includes the portion of the incoming call that is unintelligible further comprises instructions to;
determine, using natural language processing, a sentence in the incoming call that includes the portion of the incoming call that is unintelligible; and
determine, using a trained artificial intelligence model, a shortest portion of the sentence to convey a correct meaning of the portion of the incoming call that is unintelligible.

14. The system of claim 8 wherein the ambient noise level is transient.

15. A non-transitory processor readable medium containing a set of instructions thereon that when executed by a processor cause the processor to:
monitor, at a communication device, an ambient noise level;
monitor, at the communication device, a current volume level of an output element of the communication device;
receive, at the communication device, an incoming call;
identify a portion of the incoming call that is unintelligible when the ambient noise level exceeds a threshold volume level of the output element of the communications device;
determine a minimum portion of the incoming call that includes the portion of the incoming call that is unintelligible;
convert the minimum portion of the incoming call to a text based message; and
display the text based message on the communication device.

16. The medium of claim 15 further comprising instructions to:
buffer the incoming call.

17. The medium of claim 15 further comprising instructions to:
provide to a user of the communication device an option to replay the portion of the incoming call that was identified as unintelligible.

18. The medium of claim 17 further comprising instructions to:
determine the communication device is in an idle state prior to providing the option to replay the portion of the incoming call that was identified as unintelligible.

19. The medium of claim 15 wherein the instructions to determine the minimum portion of the incoming call that includes the portion of the incoming call that is unintelligible further comprises instructions to;
determine, using natural language processing, a sentence in the incoming call that includes the portion of the incoming call that is unintelligible; and
determine, using a trained artificial intelligence model, a shortest portion of the sentence to convey a correct meaning of the portion of the incoming call that is unintelligible.

20. The medium of claim 15 wherein the ambient noise level is transient.
